(19) United States
(12) Patent Application Publication
(10) Pub. No.: US 2004/0020114 A1
(43) Pub. Date: Feb. 5, 2004

(54) Cellulose support for seed

(75) Inventors: Brian E. Boehmer, Bartlett, TN (US); Jeffrey S. Hurley, Bartlett, TN (US)

Correspondence Address: DARBY & DARBY P.C., P. O. BOX 5257, NEW YORK, NY, 10150-5257, US

(73) Assignee: BKI HOLDING CORPORATION

(21) Appl. No.: 10/300,697

(22) Filed: Nov. 20, 2002

Related U.S. Application Data
(60) Provisional application No. 60/398,234, filed on Jul. 23, 2002.
(60) Provisional application No. 60/426,562, filed on Nov. 15, 2002.

(51) Int. Cl. A01C 1/06; A01C 21/00

(52) U.S. Cl. 47/57.6

(57) ABSTRACT

This invention is a bonded support for viable seeds comprising:

(A) a fiber matrix comprising cellulosic fibers,

(B) seeds,

(C) a binder activated by conditions of pressure and heat transfer to the support such that the seeds remain viable. Preferred binders are waxes with a melting point of from about 40° C. to about 120° C., and a polyolefin powder with a melting point from about 60° C. to about 220° C.

### RELATED APPLICATION DATA

This application claims priority under 35 U.S.C. § 119, based on U.S. provisional patent application serial No. 60/398,234, filed Jul. 23, 2002, and U.S. provisional patent application serial number (not yet assigned), filed Nov. 15, 2002, the entire disclosures of which are hereby incorporated by reference.

### BACKGROUND OF THE INVENTION

1. Field of the Invention

This invention is directed to a bonded support for viable seeds and a process for its production.

2. Description of Related Art

The prior art is replete with attempts to mass produce a support for seed. The potential advantages of using a support have long been recognized, but realization of a solution to the problems of manufacture have eluded those working in the field.

An ideal seed support has several desirable characteristics. It typically forms a web or strip of a matrix support. The support physically contains and retains the seed and additives at least until the support is positioned where germination and subsequent growth of the plant is desired. Because the support physically reatins the seed, spacing of the seed may be carefully controlled for optimization of plant growth and other considerations. The support also ideally contains additives such as fertilizer or other nutrients helpful for growth of the seed and young plant. Pesticides, including herbicides, insecticides and fungicides may also be incorporated in the support. Further the support may be designed to enhance moisture retention to conserve water and ensure that necessary moisture is provided for the seed. Ideally, the support should permit the passage of moisture into the underlying soil or other growth medium. The support should also allow the passage of growing roots of the plant into the soil, and plant stems upwards through the upper surface of the support. Since germination is stimulated at least in part by contact of the seed with moisture, it is important to keep the seeds dry until germination is desired. It is also important to keep the support dry if the support contains moisture sensitive fertilizer or superabsorbent polymer (SAP). The support must be sufficiently well consolidated that it can be handled during manufacture, transport and laying into the environment where the seeds are to grow.

Various binders and binder systems are used in nonwovens to provide consolidation and strength to the nonwoven material. This has been the downfall of numerous attempts at using nonwovens manufacturing techniques to produce a seed support. Two general types of binders are commonly used in nonwovens, especially airlaid nonwovens, which are emulsion polymer based binders and bicomponent fiber binders (bico). The typical manufacturing process uses the application of heat in an oven to melt the lower melting sheath component of bico fiber, or to evaporate the water of an emulsion polymer binder. In either case, the heat of the oven greatly reduces the viability of the seeds in the support.

### SUMMARY OF THE INVENTION

It would be desirable to be able to use dryforming techniques, especially airlaid techniques, to mass produce a support for seed with sufficient strength for handling and transport requirements in a process where the viability is maintained at a high level.

This invention is directed to a bonded support for viable seeds including:

(A) a fiber matrix including cellulosic fibers,

(B) seeds, and

(C) a binder activated by conditions of pressure and heat transfer to the support such that the seeds remain viable. Preferred binders include waxes having a melting point of from about 40° C. to about 120° C., and a polyolefin powder having a melting point from about 60° C. to about 220° C.

In another embodiment, the present invention is a support for the containment of viable seeds including:

(A) a first cellulosic layer containing cellulosic fibers and, optionally, a binder,

(B) a second cellulosic layer in fluid communication with the first layer, the layer containing cellulosic fibers and, optionally, a binder,

(C) optionally, a cellulosic tissue in fluid communication with the outer surface of the first or second layer,

(D) seeds distributed in a seed layer between the first cellulosic layer and the second cellulosic layer, or on a cellulosic tissue,

where the binder is present in at least one of the cellulosic layers or is in a layer in contact with one of the cellulosic layers, and

where the support has been compacted or where from about 1 to about 99 percent of the surface area of the support has been embossed, and the binder has been activated in the compacted or embossed area.

In another embodiment, the present invention is a support for the containment of viable seeds comprising:

(A) a cellulosic tissue layer,

(B) optionally, a cellulosic layer containing

(1) cellulosic fibers and a

(2) binder

(C) a seed layer containing

(1) seeds

(2) optionally, cellulosic fibers

(3) optionally, binder

(4) optionally, fertilizer, and

(D) optionally, a fertilizer layer containing

(1) cellulosic fibers

(2) fertilizer, and

(3) optionally, binder, or

(DD) optionally, a cellulosic layer containing

(1) cellulosic fiber, and

(2) optionally, binder,

where one or more layers contain binder activated by conditions of pressure and heat transfer to the support such that the seeds remain viable, where at least one layer other than the cellulosic tissue layer contains cellulosic fibers and where the order of the layers is (A), (B) if present, (C), and, if present, (D) or (DD).

This invention is also directed to a process for the production of a seed support comprising:

(A) optionally, placing a cellulosic tissue on a forming wire of an airlaying machine,

(B) airlaying a mixture containing cellulosic fibers and, optionally, a binder on the cellulosic tissue or on the forming wire to form a first cellulosic layer,

(C) distributing a layer of seeds on the tissue from (A) or on the first cellulosic layer from (B) to form a seed layer,

(D) airlaying a mixture containing cellulosic fibers and, optionally, a binder on the seed layer from (C), or on another layer to form a second cellulosic layer,

(E) where binder is present in at least one of the cellulosic layers or is in a layer in contact with one of the cellulosic layers, and

(F) compacting the support or embossing from about 1 to about 99 percent of the surface area of the support to activate the binder in the compacted or embossed area.

### DETAILED DESCRIPTION

This invention relates to a cellulose support for seeds or a seed pad which contains a relatively high percentage of viable seeds. While many seed pads of various designs have been produced by various methods in the past, no one has been able to produce a seed pad on a large manufacturing scale by a process which results in a pad containing a relatively high percentage of viable seeds.

The seed pad of this invention provides means by which a distribution of seeds and other materials can be fixed and then transported to an area favorable for seed germination and growth. Once in that area the seed pad provides a stable medium or habitat favorable for establishing the growing plants which promotes rapid growth while being resistant to erosion.

The seeds are contained in the seed layer which may constitute seeds distributed on a surface of a cellulosic layer or which may be a layer containing both seeds and fibers. A binder may also be included in the seed layer. Fertilizer may also be contained in the seed layer. The seed layer may also be a layer containing seeds, fibers, fertilizer and binder.

The cellulosic layers contain cellulosic fibers and, optionally, binder. Binder generally is located in at least one of the cellulosic layers. While it is desirable to use as little binder as possible, enough binder must be used to maintain structural integrity of the pad. Any cellulose fibers known in the art, including cellulose fibers of any natural origin, such as those derived from wood pulp, may be used in a cellulosic layer. Preferred cellulose fibers include, but are not limited to, digested fibers, such as kraft, prehydrolyzed kraft, soda, sulfite, chemi-thermal mechanical, and thermo-mechanical treated fibers, derived from softwood, hardwood or cotton linters. More preferred cellulose fibers include, but are not limited to, kraft digested fibers, including prehydrolyzed kraft digested fibers. Suitable for use in this invention are the cellulose fibers derived from softwoods, such as pines, firs, and spruces. Other suitable cellulose fibers include those derived from Esparto grass, bagasse, kemp, flax and other lignaceous and cellulosic fiber sources. Suitable cellulose fibers include, but are not limited to, bleached Kraft southern pine fibers sold under the trademark FOLEY FLUFFS® which are available from Buckeye Technologies Inc. of Memphis, Tenn.

In one embodiment of this invention, fibers suitable for use in the structures of the invention may include cellulosic or synthetic fibers or blends thereof. Most preferred is wood cellulose. Also preferred is cotton linter pulp, chemically modified cellulose such as crosslinked cellulose fibers and highly purified cellulose fibers, such as Buckeye HPF (each available from Buckeye Technologies Inc., Memphis, Tenn.). The fluff fibers may be blended with synthetic fibers, for example polyester such as PET, nylon, polyethylene or polypropylene.

The fiber-containing cellulosic layer may also include thermoplastic binding material, which may be blended with the cellulosic or synthetic fibers. Suitable thermoplastic binding material includes thermoplastic fibers, such as bicomponent thermoplastic fibers (bico). Preferred thermoplastic binding fibers provide enhanced adhesion for a wide range of materials, including synthetic and natural fibers, particles, and synthetic and natural carrier sheets. An exemplary thermoplastic bico fiber is Celbond Type 255 Bico fiber from KoSa, Charlotte, N.C.

Other suitable thermoplastic fibers include polypropylenes, polyesters, nylons and other olefins, or modifications thereof. Another preferred thermoplastic fiber is FiberVisions type AL-Adhesion-C Bicomponent Fiber, which contains a polypropylene core and an activated copolyolefin sheath.

When layers of the pad contain a mixture of cellulosic and synthetic fibers, and a synthetic fiber binder is used, the synthetic fiber binder generally is present in an amount of from about 1 to about 20 gsm (grams/square meter) of the layer. This may amount to from about 2 to about 50 percent by weight of the layer.

In one embodiment of the pad, in addition to the seed layer and cellulosic layers the pad contains a fertilizer layer (1) between the seed layer and either the first cellulosic layer or the second cellulosic layer, or (2) on the surface opposed to the surface in contact with the seed layer of either the first cellulosic layer or the second cellulosic layer. A wide variety of fertilizer formulations are available in the state of the art, and many are suitable for use in the pad of this invention. For example, 10-20-20 Starter Fertilizer from Lesco of Strongville, Ohio, where the numbering refers to the N (nitrogen), P (phosphorous) and K (potassium) content.

Several embodiments are contemplated by the present invention. In one, the support has a tissue layer covered by a layer containing seeds and fiber or of seeds, fiber and binder, or of seeds, fiber, fertilizer and binder. In another, the support has a tissue layer covered by a layer of fiber or of fiber and binder, which is covered by a layer containing seeds and fiber, or seeds, fiber and binder, or seeds, fiber, fertilizer and binder. Another variation of support has a tissue layer covered by a layer of seeds and fiber or of seeds, fiber and binder, which is then covered with a layer of fertilizer and fiber, or of fertilizer, fiber and binder. A further variation of the support has a tissue layer covered by a layer of seeds or of seeds and binder, which is covered by a layer of cellulose fiber or of cellulose fiber and binder.

The pad may also contain superabsorbent polymer. A superabsorbent polymer (SAP) is a water soluble compound that has been cross-linked to render it water insoluble but still swellable to at least about 15 times its own weight in physiological saline solution. These superabsorbent materials generally fall into three classes, namely starch graft copolymers, cross-linked carboxymethylcellulose derivatives, and modified hydrophilic polyacrylates. Examples of absorbent polymers include hydrolyzed starch-acrylontrile graft co-polymer, saponified acrylic acid ester-vinyl co-polymer, modified cross-linked polyvinyl alcohol, neutralized cross-linked polyacrylic acid, cross-linked polyacrylate salt, and carboxylated cellulose. The preferred superabsorbent materials, upon absorbing fluids, form hydrogels. Preferred superabsorbents are agricultural SAPs which are often potassium salts rather than sodium salts. A preferred superabsorbent is an agricultural SAP designated Airdall 1460 available from BASF Corp., Charlotte, N.C.

SAP may be present in one or more layers of the pad, generally a cellulosic layer, or is present as a separate layer, optionally mixed with cellulosic fibers, binder or fibers and binder.

Binder is used to stabilize and consolidate the pad. Desirable binders for the seed pad of this invention include materials with low environmental impact, including waxes and polyolefin based materials. Easily biodegradable materials are preferred. Binders may be in the form of fibers, such as bicomponent fibers mentioned above, in the form of powders such as, for example, polyolefin powders like polyethylene such as, for example a polyethylene powder having a melting point of 128° C., or in the form of particles such as, for example, the prilled paraffin waxes including R-7152 and MIWSH 109 mini prilled, 78° C. melting point, Moore and Munger, Inc., Shelton, Conn. Latex binders may also be used and desirable binders include lattices based on biodegradable polymers such as, for example, polylactic acids. In alternative embodiments, the other emulsion polymer lattices may be used alone or in combination with other binders, including, for example, acrylates, styrene-butadiene, ethylene vinyl acetate, and synthetic lattices or nonaqueous solvent based lattices or solutions. Various binders may be used in a variety of combinations in the seed pad.

Hot melt adhesives are commonly used to assemble various nonwoven components into more elaborate structures. In another embodiment of this invention, hot melt adhesives may be used to produce the support from components. An example of a hot melt adhesive is an ethylene vinylacetate (EVA)-based adhesive (H1477B, Bostik Findley, Middleton, Mass.).

Desirable thermoplastic binders have a melting point of from about 60° C. to about 220° C. Desirable waxes suitable for use as binders in this invention have a melting point of from about 60° C. to about 120° C. Desirable polyolefins, including polyolefin powders, suitable for use as binders in this invention have a melting point of from about 60° C. to about 220° C.

A wide variety of seeds, including spores and other reproductive parts of plants, are suitable for use in this invention including grasses, vegetables, flowers, trees, all manner of agricultural crops and the like.

The seed pad of this invention may be produced by several processes for the production of nonwovens. Dryforming techniques such as airlaying are preferred. Several manufacturers make airlaid web forming machines, including M&J Fibretech of Denmark and Dan-Web, also of Denmark. The forming heads include rotating drums, or agitators generally in a racetrack configuration, which serve to maintain fiber separation until the fibers are pulled by vacuum onto a foraminous condensing drum or foraminous forming conveyor (or forming wire). For example, in machines manufactured by M&J Fibretech, the forming head includes a rotary agitator above a screen. Other fibers, such as a synthetic thermoplastic fiber, may also be introduced to the forming head through a fiber dosing system, which includes a fiber opener, a dosing unit and an air conveyor.

Production of the pad in an airlaid manufacturing process is possible provided that the usual manufacturing conditions are moderated so as to maintain a high viability rate for the seeds. Generally, this means not exposing the pad to temperatures and pressures lethal to the seeds, or in limiting the area of exposure, so that seeds are sacrificed in limited areas where the binder is activated. If ovens are used to activate the binder, the binder must be amenable to activation at the relatively low temperatures required to maintain viability of the seeds. The pad may be compacted at one or more points in the manufacturing process.

A preferred process for the manufacture of the seed pad includes the use of embossing techniques to activate the binder in the embossed areas. This can be accomplished with a heated embossing roll which embosses from about 1 to about 99 percent of the area of the pad, preferably from about 1 to about 50 percent of the area of the pad, more preferably from about 2 to about 20 percent of the area of the pad. Alternatively, the pad may be formed on patterned forming wire and then passed over a smooth compaction roll which is heated. Heat sufficient to activate the binder is transferred to the pad in the raised areas of the forming wire, while relatively little heat is transferred to the pad in other areas. Forming wires can be used which emboss from about 1 to about 99 percent of the area of the pad, preferably from about 1 to about 50 percent of the area of the pad, more preferably from about 2 to about 20 percent of the area of the pad.

A preferred method for the production of the pad includes the use of these embossing techniques with binder activation limited to the areas to be embossed. In an alternative embodiment, the method for the production of the pad includes the use of embossing techniques with the use of binder limited to the areas to be embossed.

In another preferred process for the manufacture of the pad, structural integrity is provided to the web by compaction, heat or a combination of the two such that a low melting bonding material is sufficiently activated to provide the requisite bonding. The use of heat alone or compaction alone may also provide sufficient bonding in certain structures. Increasing the level of compaction or temperature, up to a certain level to ensure maximum activation of the bonding material, will increase the level of bonding. Bonding material is distributed throughout the structure such that activation of the bonding material will bind the multiple layers and sufficiently secure the seeds, fertilizer, superabsorbents, cellulose and other particles and fibers within the structure and minimize the loss thereof in handling. This bonding step can be accomplished by a variety of means that do not necessarily require the use of an oven to activate the bonding material. A primary consideration is that the bonding step be accomplished under conditions of pressure and heat transfer to the support such that the seeds remain viable.

A smooth compaction roll located at any point in the process can be pressed against the web at a pressure of 0 kPa to 5000 kPa and a temperature of 0° C. to 270° C. to activate the bonding material. The smooth roll may be in direct contact with the web or a felt or wire may be provided between the web and the smooth compaction roll. The web may have another smooth roll opposite the first smooth roll or it may have a felt or wire between it and the second smooth roll.

The above bonding process may also include a wire or felt that has a pattern woven or integrated into the wire or has a raised surface such that the pattern of the raised surface gives certain portions of the wire a higher caliper than the rest of the wire. These higher caliper raised areas of the felt or wire will produce more pressure upon compaction, thus embossing the web. These embossed areas that correlate to the raised caliper portions of the web or felt will have a higher level of bonding than the surrounding areas due to the higher compaction that they will undergo. Such wires are available from companies such as Albany International, Portland, Tenn. or Voith Fabrics, Haaksbergen, Holland. The raised surfaces of the wire of felt can vary from 0.1 mm to 25 mm.

An emboss roll, located between the forming heads, but preferably after the final forming head, can be pressed against the web at a pressure of 0 kPa to 5000 kPa and a temperature of 0° C. to 270° C. to activate the bonding material. The emboss roll is preferably in direct contact with the web, but the forming line may also have a felt or wire which is provided between the web and the emboss roll. The raised surfaces of the emboss roll will produce a higher pressure on the web at these points which will provide enhanced bonding in these areas.

For any embossing process which employs a heated element, whether it is an embossing roll, or a smooth roll against which the web is embossed, heat is transferred more effectively in the compacted area to produce bonding. Less heat is transferred in the areas of the web which are not compacted or embossed. Thus, if the seeds are sensitive to temperature, fewer seeds may remain viable in the embossed areas, while seeds in the areas which are not embossed may retain high viability. While generally more moderate temperatures are used in the manufacture of the seed pad, the exact temperature setting of any individual element in a dryforming line is not important. The web being formed moves over the heated elements. It is important that combinations of contact time, contact pressure and temperature are sufficient to transfer enough heat in the heated or embossed areas to activate the binder, under conditions of pressure and heat transfer to the support such that the seeds remain viable in the surrounding areas of the pad.

Activation of solid binders in fiber and powder form requires melting some portion of the binder so that the liquid or plastic binder can flow around the constituents of the web at least in the immediate area, followed by cooling to set the binder. Thus, physical integrity is imparted to the web. In the case of a liquid binder with a polymer such as an emulsion polymer applied to the web in a latex or in a solution, activation involves sufficient heat transfer to thicken and set the polymer, usually with vaporization of the water or other solvent. Fast hardening latexes which set without the necessity of removing all the water may be used in this invention. The use of aqueous binders or of a water spray to prevent dust off must be accomplished in a manner that heating to remove the solvent does not kill the seeds.

As used herein, the phrase “activated by conditions of pressure and heat transfer to the seeds such that the seeds remain viable” means that under conditions conducive to growth, at least about 50 percent of the seeds in the support germinate and start growth above the surface of the support. While 50 percent may be regarded as the minimum acceptable, desirably, at least about 65 percent of the seeds in the support germinate and start growth above the surface of the support, while preferably, at least about 80 percent of the seeds in the support germinate and start growth above the surface of the support, and more preferably, at least about 90 percent of the seeds in the support germinate and start growth above the surface of the support. Activated means capable of activation or has been activated While it is desirable to use seeds with a high inherent viability in the manufacture of the support, not all seed supplies are of equal inherent viability. Thus, in relation to the viability criterion defined in the preceding paragraph, the phrase “such that the seeds remain viable” must be understood to refer to the viable seeds used in producing the support. Only a viable seed can remain viable. So, the phrase “at least about 50 percent of the seeds in the support germinate and start growth above the surface of the support”, means that at least about 50 percent of the viable seeds put into the support were able to grow. Only in rare instances will the percentage of viable seeds actually be increased by the manufacturing process.

Conditions of heat and pressure may include any combination of heat from ambient to elevated and of pressure from below ambient to elevated as required by the manufacturing process, provided that the aforementioned viability conditions are met. If heating alone is used to the activate the binder, the condition of pressure is simply that of the ambient atmosphere pressing on the top of the support or the weight of the support resting on a surface. In some cases the pressure of compaction at ambient temperatures with no applied heating may be sufficient to activate the binder.

In one embodiment, the binder is a low temperature binder which can be activated by conditions of pressure and heat within a residence time at an activation temperature which is less than a higher temperature at which viability of the seeds is reduced to less than about 50 percent. When the support is placed under conditions of pressure and temperature for a given residence time before cooling, there is a temperature at which viability of the seeds is reduced to less than the acceptable limit of about 50 percent. Experience has shown that for most seeds, if the support is subjected to the same conditions for the same residence time before cooling, except that the temperature is higher, fewer seeds remain viable. Therefore, in this embodiment activation of the binder must be possible under milder conditions than those which result in unacceptable viability. More desirably, the binder is a low temperature binder which can be activated by conditions of pressure and heat within a residence time at an activation temperature which is less than a higher temperature at which viability of the seeds is reduced to less than about 65 percent, preferably the binder is a low temperature binder which can be activated by conditions of pressure and heat within a residence time at an activation temperature which is less than a higher temperature at which viability of the seeds is reduced to less than about 80 percent and more preferably, the binder is a low temperature binder which can be activated by conditions of pressure and heat within a residence time at an activation temperature which is less than a higher temperature at which viability of the seeds is reduced to less than about 90 percent.

The support of this invention may be compacted. Alternatively, from about 1 to about 99 percent of the surface area of the support may be embossed It is desirable that the binder has been activated in the compacted or embossed area. In variations of this embodiment, from about 1 to about 50 percent of the surface area of the support has been embossed, or from about 1 to about 25 percent of the surface area of the support has been embossed, or from about 1 to about 10 percent of the surface area of the support has been embossed, or from about 1 to about 5 percent of the surface area of the support has been embossed.

Various materials, structures and manufacturing processes useful in the practice of this invention are disclosed in U.S. Pat. Nos. 6,241,713; 6,353,148; 6,353,148; 6,171,441; 6,159,335; 5,695,486; 6,344,109; 5,068,079; 5,269,049; 5,693,162; 5,922,163; 6,007,653; and 6,355,079; and in U.S. patent applications with serial numbers and filing dates, Ser. No. 09/211,935 filed Dec. 15, 1998; Ser. No. 09/232,783 filed Jan. 19, 1999; Ser. No. 09/719,338 filed Jan. 17, 2001; Ser. No. 09/475,850 filed Dec. 30, 1999; Ser. No. 09/469,930 filed Dec. 21, 1999; Ser. No. 09/578,603 filed May 25, 2000; Ser. No. 05/593,409 filed Jun. 14, 2000; Ser. No. 09/325,764 filed Jun. 8, 1999 allowed; Ser. No. 09/774,248 filed Jan. 30, 2001; and Ser. No. 09/854,179 filed May 11, 2001, all of which are hereby incorporated by reference in their entirety.

All patents, patent applications and publications cited in this written description are hereby incorporated by reference in their entirety. In case of conflict in terminology, the present disclosure controls.

### EXAMPLES

The following examples are presented to provide a more detailed understanding of the invention. The specific materials and parameters are exemplary and are not intended to limit the scope of the invention.

### Examples 1 Through 4

### Laboratory Development of Seed Pads

### Example 1

### Laboratory Demonstration of Wax as an Airlaid Binder

A 35.56 cm by 35.56 cm piece of 18 gsm tissue (CelluTissue 3204, CelluTissue Holdings, Inc., East Hartford, Conn.) was placed on the screen in the laboratory padformer. A first layer consisting of 5.05 grams (38 gsm) of fluff pulp (FOLEY FLUFFS®, Buckeye Technologies Inc., Memphis, Tenn.,) was mixed with 6.64 grams (50 gsm) of prilled paraffin wax (R-7129, Moore and Munger, Inc., Shelton, Conn.) and blown onto the tissue. The R-7129 wax has a melting point range of 52.8-53.8° C., and typical value of 53.8° C. A second layer consisting only of 9.83 grams (74 gsm) of FOLEY FLUFFS® fluff pulp was added to the pad. A third layer was formed on top using 5.05 grams (38 gsm) of FOLEY FLUFFS® fluff pulp and 6.64 grams (50 gsm) of prilled paraffin wax (R-7129). The pad was pressed at 52.7 kPa for two minutes and then heated at 64° C. for ten minutes. The product was then embossed over approximately 5 percent of the pad's area using a pressure of 52.7 kPa and a temperature of 60° C. for 5 seconds. The absorbent structure had an overall basis weight of 268 gsm.

### Example 2

### Laboratory Demonstration of Seed Pad Recipe Versatility

A lab pad was made using defiberized newsprint instead of FOLEY FLUFFS® fluff pulp. A piece of 18 gsm tissue (CelluTissue 3204) was placed on the screen of the laboratory padformer. A first layer consisting of 6.51 grams (49 gsm) of defiberized newsprint was blown onto the tissue using the padformer. An intermediate layer consisting of 1.33 grams (10 gsm) of prilled paraffin wax (R-4927, Moore and Monger, Inc., Shelton, Conn.) was blown on top of the newsprint layer. The R-4927 grade wax has a melting point range of 53.3-54.4° C., and a typical melting point of 53.8° C. Defiberized newsprint at a level of 4.54 grams (34.2 gsm) was mixed with 1.30 grams (9.8 gsm) of grass seeds (PennTrio bentgrass seeds, Tee-2-Green Corp., Hubbard, Oreg.) and added as a third layer. The seed layer was then covered with 6.51 grams (49 gsm) of defiberized newsprint. The 170 gsm material was embossed over 5 percent of the surface at a pressure of 52.7 kPa and a temperature of 60° C. to impart stability to the sample.

### Examples 3 and 4

### Laboratory Demonstration of Fertilizer-Containing Seed Pads

### Example 3

### Laboratory Demonstration of the Use of Fertilizer in Seed Pads

In the laboratory padformer, a 35.56 cm by 35.56 cm sample was formed by blowing a mixture of 2.53 grams (20 gsm) of FOLEY FLUFFS® fluff pulp and 0.63 grams (5 gsm) of prilled paraffin wax (R-7152, Moore and Munger, Inc., Shelton, Conn.) onto 18 gsm tissue (CelluTissue 3204). The R-7152 grade wax has a melting point range of 65.6-67.8° C., and a typical melting point of 66.1° C. The pad was removed from the padformer, and the surface was sprinkled with 6.07 grams (48 gsm) of seeds (fescue seeds, Transition Blend, Lesco, Strongsville, Ohio) by hand. The pad was then returned to the padformer, and 2.53 grams (20 gsm) of FOLEY FLUFFS® fluff pulp was blown onto the pad. The pad was again removed from the padformer, so 3.03 grams (24 gsm) of fertilizer (10-20-20 Starter Fertilizer, Lesco) could be added to the surface by hand. The pad was returned to the padformer, and a mixture of 2.53 grams (20 gsm) of FOLEY FLUFFS® fluff pulp B and 0.63 grams (5 gsm) of prilled paraffin wax (R-7152) was blown onto the surface of the pad. The pad was embossed over 5 percent of its surface using a temperature of 90° C. in a Carver press set to 175.9 kPa of pressure. Using this 160 gsm formulation, the fertilizer particles were able to come through the FOLEY FLUFFS®/wax layer.

### Example 4

### Laboratory Demonstration of the Retention of Fertilizer in Seed Pads

Tto enhance retention of the fertilizer in the web, another pad was made. In this case, 5.06 grams (40 gsm) of FOLEY FLUFFS® fluff pulp was mixed with 1.26 grams (10 gsm) of prilled paraffin wax (R-7152) and blown onto 18 gsm tissue (CelluTissue 3204). The pad was removed from the padformer and covered with seeds and fertilizer by hand. Seeds (fescue seeds, Transition Blend, Lesco) were used at a level of 48 gsm (6.07 grams), and the fertilizer (10-20-20 Starter Fertilizer, Lesco) was used at a level of 24 gsm (3.03 grams). The pad was returned to the padformer where a mixture of 6.33 grams (50 gsm) of FOLEY FLUFFS® fluff pulp and 1.58 grams (12.5 gsm) of prilled paraffin wax (R-7152) was blown on top. The pad was embossed on approximately 5 percent of its surface using a temperature of 90° C. in a Carver press set to 175.9 kPa of pressure. The fertilizer was contained well in this 202.5 gsm structure.

### Examples 5-34

### Pilot Development of Seed Pads

### Example 5

### Evaluation of Binder Versatility

An unbonded web was made on the pilot line to determine if other types of binders could be used successfully in the seed pad application. A carrier tissue (18 gsm CelluTissue 3204) was unwound onto the forming wire of a three-head airlaid pilot machine. A first layer consisting of 80 gsm of FOLEY FLUFFS® fluff pulp was blown onto the tissue. A second layer of 64.2 gsm of FOLEY FLUFFS® fluff pulp mixed with 9.8 gsm seed (bentgrass seed, PennTrio, Tee-2-Green Corp., Hubbard, Oreg.) was added to the structure. This layer was followed by a third layer consisting of 80 gsm of FOLEY FLUFFS® fluff pulp. A second piece of 18 gsm tissue (CelluTissue 3204) was manually added on top of the structure and a small roll of material was collected. In a second operation, the top tissue was removed, and the material was bound by spraying 30 gsm of an EVA-based hot melt adhesive (H1477B, Bostik Findley, Middleton, Mass.) on each side. In this 312 gsm seed pad, the glue did not add significant heat to the seeds and thus they did not suffer significant heat shock.

### Example 6

### Pilot Production of Seed Pad With a High Loading of Bentgrass Seeds

A 2-ply 18 gsm carrier tissue (CelluTissue 1600, CelluTissue Holdings, Inc., East Hartford, Conn.) was unrolled onto the forming wire of a pilot airlaid machine containing three forming heads. The first or bottom layer of the material contained 80 gsm of FOLEY FLUFFS® fluff pulp. As an intermediate layer 6 gsm of prilled paraffin wax (R-4927) was added on top of the fluff pulp using a powder feeder (Coat-O-Matic 23″ DE-S, Christy Machine Company, Fremont, Ohio). A second layer of 64 gsm of FOLEY FLUFFS® fluff pulp mixed with 50 gsm of seeds (creeping bentgrass seeds, PennTrio, Tee-2-Green Corp., Hubbard, Oreg.) was added through the second forming head. A third layer of 80 gsm FOLEY FLUFFS® fluff pulp was added through the third forming head. A patterned emboss roll was heated to 60° C. The pattern on the roll consisted of about 5 percent of the roll's total area. The emboss roll was pressed onto the web. The heat, combined with 200 kPa of pressure, melted the wax in the emboss areas to bond the web. The discontinuous bonding of the web caused minimal heat shock to the agricultural additives. A roll of this web was collected at an overall basis weight of 298 gsm and a density of 0.1 g/cc.

### Example 7

### Reduced Loading of Bentgrass Seeds

The pad was prepared as in Example 6, except that the amount of seed (creeping bentgrass seeds, PennTrio, Tee-2-Green Corp., Hubbard, Oreg.) being fed through the second forming head was reduced to 10 gsm. A roll of this web was collected at an overall basis weight of 246 gsm and a density of 0.1 g/cc.

### Example 8

### Reduced Basis Weight of Pad With Bentgrass Seeds

The core was prepared as in Example 7, except that the amount of FOLEY FLUFFS® fluff pulp in the first or bottom layer was reduced to 49 gsm. The amount of FOLEY FLUFFS® fluff pulp was reduced to 34 gsm in the second layer and 49 gsm in the third layer. The material was collected at these settings had an overall basis weight of 156 gsm and a density of 0.1 g/cc.

### Example 9

### Lower Basis Weight Pad Containing Fescue Seeds

The pad was prepared as in Example 8, except that 10 gsm of fescue seed (Transition Blend, Lesco) was fed through the second forming head instead of the bentgrass seeds. The material was collected at an overall basis weight of 145 gsm and a density of 0.1 g/cc.

### Example 10

### Increased Loading of Fescue Seeds

An attempt was made to make a pad as described in Example 9 except having an increased loading of seeds. The loading of fescue seeds (Transition Blend, Lesco) was limited by the capability of the powder feeder (Coat-O-Matic 23″ DE-S, Christy Machine Company, Fremont, Ohio) and could not be increased above the 10 gsm level.

TABLE 1
Formation Description for Examples 6 through 9.

| | | Drop | | Drop | Forming |
|---|---|---|---|---|---|
| Example | Forming Head 1 | Spreader | Forming Head 2 | Spreader | Head 3 |
| 6 | 80 gsm fluff pulp | 6 gsm R- | 64 gsm fluff pulp + | N/A | 80 gsm fluff |
| | | 4927 wax | 50 gsm creeping | | pulp |
| | | | bentgrass | | |
| 7 | 80 gsm fluff pulp | 6 gsm R- | 64 gsm fluff pulp + | N/A | 80 gsm fluff |
| | | 4927 wax | 10 gsm creeping | | pulp |
| | | | bentgrass | | |
| 8 | 49 gsm fluff pulp | 6 gsm R- | 34 gsm fluff pulp + | N/A | 49 gsm fluff |
| | | 4927 wax | 10 gsm creeping | | pulp |
| | | | bentgrass | | |
| 9 | 49 gsm fluff pulp | 6 gsm R- | 34 gsm fluff pulp + | N/A | 49 gsm fluff |
| | | 4927 wax | 10 gsm fescue | | pulp |

### Example 11

### Preparation of Seed Pads With a Higher Melting Paraffin Binder

A 1-ply 18 gsm carrier tissue (CelluTissue 3204) was unrolled onto the forming wire of a pilot airlaid machine containing three forming heads. The first or bottom layer of the material contained 50 gsm of FOLEY FLUFFS® fluff pulp mixed with 22 gsm of prilled paraffin wax (R-7152, Moore and Munger, Inc., Shelton, Conn.). An intermediate layer of 10 gsm seeds (creeping bentgrass seeds, PennTrio, Tee-2-Green Corp., Hubbard, Oreg.) was added to the web through a drop spreader (AccuGreen 1000, The Scotts Company, Marysville, Ohio) mounted between the first and second forming heads. A second layer of 40 gsm of FOLEY FLUFFS® fluff pulp was added through the second forming head. A patterned emboss roll was heated to 70° C. The pattern on the roll consisted of about 5 percent of the roll's total area. The emboss roll was pressed onto the web. The heat, combined with 200 kPa of pressure, melted the wax in the emboss areas to bond the web. The discontinuous bonding of the web caused minimal heat shock to the agricultural additives. A roll of this web was collected at an overall basis weight of 137 gsm and a density of 0.13 g/cc.

### Example 12

### Seed Pad With Higher Melt Paraffin and Fescue Seeds

The pad was prepared as in Example 11, except that 110 gsm of fescue seeds (Transition Blend, Lesco) were added from the drop spreader. The material was collected at an overall basis weight of 240 gsm and a density of 0.16 g/cc.

### Example 13

### Seed Pad With Higher Melt Paraffin and Bluegrass Seeds

The pad was prepared as in Example 12, except that 15 gsm of bluegrass seeds (Lesco) were added through the drop spreader. The material was collected at an overall basis weight of 156 gsm and a density of 0.12 g/cc.

TABLE 2
Formation Description for Examples 11 through 13.

| | | Drop | | Drop | Forming |
|---|---|---|---|---|---|
| Example | Forming Head 1 | Spreader | Forming Head 2 | Spreader | Head 3 |
| 11 | 50 gsm fluff pulp + | 10 gsm | 40 gsm fluff pulp | N/A | N/A |
| | 22 gsm R-7152 | creeping | | | |
| | wax | bentgrass | | | |
| 12 | 50 gsm fluff pulp + | 110 gsm | 40 gsm fluff pulp | N/A | N/A |
| | 22 gsm R-7152 | fescue | | | |
| | wax | | | | |
| 13 | 50 gsm fluff pulp + | 15 gsm | 40 gsm fluff pulp | N/A | N/A |
| | 22 gsm R-7152 | bluegrass | | | |
| | wax | | | | |

### Example 14

### Preparation of Seed Pads With a Higher Melting Binder and Fertilizer

A 1-ply 18 gsm carrier tissue (CelluTissue 3204) was unrolled onto the forming wire of a pilot airlaid machine containing three forming heads. The first or bottom layer of the material contained 50 gsm of FOLEY FLUFFS® fluff pulp mixed with 22 gsm of prilled Fischer-Tropsch wax (Paraflint ® H4, Moore and Munger, Inc., Shelton, Conn.). The H4 grade wax is a hard, high melting point, low viscosity wax having a congealing point of 96.1-100° C., and a typical value of 97.2° C. An intermediate layer of 14.7 gsm seeds (bluegrass seeds, Lesco) was added to the web through a drop spreader (AccuGreen 1000) mounted between the first and second forming heads. Nothing was added through the second forming head. A layer of 24 gsm of fertilizer (Starter Fertilizer, Lesco) was added through a second drop spreader (AccuGreen 1000) mounted between the second and third forming heads. A second layer of 40 gsm of FOLEY FLUFFS® fluff pulp was added through the third forming head. A patterned emboss roll was heated to 90° C. The pattern on the roll consisted of about 5 percent of the roll's total area. The emboss roll was pressed onto the web. The heat, combined with 200 kPa of pressure, melted the wax in the emboss areas to bond the web. The discontinuous bonding of the web caused minimal heat shock to the agricultural additives. A roll of this web was collected at an overall basis weight of 170 gsm and a density of 0.1 g/cc.

GERMINATION TESTING: The cellulose support for seed of Example 14 was tested for germination according to the rules of the Association of Official Seed Analysts, Inc., PMB #411, 1763 East University Blvd., Suite A, Las Cruces, N. Mex. (hereafter “AOSA” rules). The Certificate of viability reported 78 percent germination for the support and for the Kentucky Bluegrass seed itself 86 percent germination. Thus, 91 percent of the viable seeds in the support germinated.

### Example 15

### Preparation of Bluegrass/Ryegrass Pads With a Higher Melting Binder and Fertilizer

The pad was prepared as in Example 14, except that 19.2 gsm of a blend of 50 percent bluegrass and 50 percent rye grass (Lesco, Strongsville, Ohio) was fed through the drop spreader mounted between forming heads one and two. The pad had an overall basis weight of 174 gsm and a density of 0.1 g/cc.

GERMINATION TESTING: The cellulose support for seed of Example 15 was tested for germination according to the AOSA rules. The Certificate of viability reported 81 percent germination for Kentucky Bluegrass and 81 percent for the ryegrass in the support. The Certificate of Viability for the seed mixture reported 88 percent germination for both seeds themselves. Thus, 92 percent of the viable seeds in the support germinated.

### Example 16

### Preparation of Fescue Pads With a Higher Melting Binder and Fertilizer

The pad was prepared as in Example 15, except that 48 gsm of fescue seeds (Lesco, Strongsville, Ohio) was fed through the drop spreader mounted between forming heads one and two. The pad had an overall basis weight of 203 gsm and a density of 0.1 g/cc.

GERMINATION TESTING: The cellulose support for seed of Example 16 was tested for germination according to the AOSA rules. The Certificate of viability reported 92 percent germination for the support. The Certificate of Viability for the tall fescue reports 96 percent germination for the seed itself. Thus, 96 percent of the viable seeds in the support germinated.

TABLE 3
Formation Description for Examples 14 through 16.

| | | Drop | | Drop | Forming |
|---|---|---|---|---|---|
| Example | Forming Head 1 | Spreader | Forming Head 2 | Spreader | Head 3 |
| 14 | 50 gsm fluff pulp + | 15 gsm | N/A | 24 gsm | 40 gsm fluff |
| | 22 gsm Fischer- | bluegrass | | fertilizer | pulp |
| | Tropsch wax | | | | |
| 15 | 50 gsm fluff pulp + | 19.2 gsm | N/A | 24 gsm | 40 gsm fluff |
| | 22 gsm Fischer- | bluegrass/ | | fertilizer | pulp |
| | Tropsch wax | ryegrass | | | |
| | | blend | | | |
| 16 | 50 gsm fluff pulp + | 48 gsm | N/A | 24 gsm | 40 gsm fluff |
| | 22 gsm Fischer- | fescue | | fertilizer | pulp |
| | Tropsch wax | | | | |

### Example 17

### Preparation of Seed Pads With a Polyethylene Binder and Fertilizer

A 1-ply 18 gsm carrier tissue (CelluTissue 3204) was unrolled onto the forming wire of a pilot airlaid machine containing three forming heads. The first or bottom layer of the material contained 50 gsm of FOLEY FLUFFS® fluff pulp mixed with 10 gsm of powdered polyethylene (Polyethylene 959S low density, Dow Chemical Company, Midland, Mich.). An intermediate layer of 14.7 gsm seeds (bluegrass seeds, Lesco) was added to the web through a drop spreader (AccuGreen 1000) mounted between the first and second forming heads. Nothing was added through the second forming head. A layer of 24 gsm of fertilizer (Starter Fertilizer, Lesco) was added through a second drop spreader (AccuGreen 1000) mounted between the second and third forming heads. A second layer of 40 gsm of FOLEY FLUFFS® fluff pulp mixed with 12.5 gsm of powdered polyethylene (Polyethylene 959S low density) was added through the third forming head. A patterned emboss roll was heated to 100° C. The pattern on the roll consisted of about 5 percent of the roll's total area. The emboss roll was pressed onto the web. The heat, combined with 200 kPa of pressure, melted the wax in the emboss areas to bond the web. The discontinuous bonding of the web causes minimal heat shock to the agricultural additives. A roll of this web was collected at an overall basis weight of 170 gsm and a density of 0.1 g/cc.

GERMINATION TESTING: The cellulose support for seed of Example 17 was tested for germination according to the AOSA rules. The Certificate of viability reported 84 percent germination for the support. The Certificate of Viability for the Kentucky Bluegrass reported 86 percent germination for the seed itself. Thus, 98 percent of the viable seeds in the support germinated.

### Example 18

### Preparation of Bluegrass/Ryegrass Pads With a Polyethylene Binder and Fertilizer

The pad was prepared as in Example 17, except that 19.2 gsm of a blend of 50 percent bluegrass and 50 percent rye grass (Lesco) was fed through the drop spreader mounted between forming heads one and two. The pad had an overall basis weight of 174 gsm and a density of 0.1 g/cc.

GERMINATION TESTING: The cellulose support for seed of Example 18 was tested for germination according to the AOSA rules. The Certificate of viability reported 89 percent germination for Kentucky Bluegrass and 89 percent for the ryegrass in the support. The Certificate of Viability for the seed mixture reported 88 percent germination for both seeds themselves. Thus, about 100 percent of the viable seeds in the support germinated.

### Example 19

### Preparation of Fescue Pads With a Polyethylene Binder and Fertilizer

The pad was prepared as in Example 18, except that 48 gsm of fescue seeds (Lesco) was fed through the drop spreader mounted between forming heads one and two. The pad had an overall basis weight of 203 gsm and a density of 0.1 g/cc.

GERMINATION TESTING: The cellulose support for seed of Example 19 was tested for germination according to the AOSA rules. The Certificate of viability reported 94 percent germination for the support. The Certificate of Viability for the tall fescue reported 96 percent germination for the seed itself. Thus, 98 percent of the viable seeds in the support germinated.

### Example 20

### Preparation of Fescue Pads With Treated Pulp, a Polyethylene Binder and Fertilizer

The pad was prepared as in Example 19, except treated pulp (treated as described in U.S. patent application Ser. No. 09/469,930 filed Dec. 21, 1999) (CARESSA, Buckeye Technologies, Inc., Memphis, Tenn.) was used instead of FOLEY FLUFFS®. The pad had an overall basis weight of 203 gsm and a density of 0.1 g/cc.

GERMINATION TESTING: The cellulose support for seed of Example 20 was tested for germination according to the AOSA rules. The Certificate of viability reported 88 percent germination for the support. The Certificate of Viability for the tall fescue reported 96 percent germination for the seed itself. Thus, 92 percent of the viable seeds in the support germinated.

### Example 21

### Preparation of Fescue Pads With Treated Pulp, a Polyethylene Binder and Fertilizer

The pad was prepared as in Example 19, except 10 gsm superabsorbent polymer (Airdall 1460, BASF Corp., Charlotte, N.C.) was mixed with the fertilizer in the drop spreader located between forming heads two and three. The pad had an overall basis weight of 203 gsm and a density of 0.1 g/cc.

GERMINATION TESTING: The cellulose support for seed of Example 21 was tested for germination according to the AOSA. The Certificate of viability reported 79 percent germination for the support. The Certificate of Viability for the tall fescue reported 96 percent germination for the seed itself. Thus, 82 percent of the viable seeds in the support germinated.

TABLE 4
Formation Description for Examples 17 through 21.

| | | Drop | Forming | | |
|---|---|---|---|---|---|
| Example | Forming Head 1 | Spreader | Head 2 | Drop Spreader | Forming Head 3 |
| 17 | 50 gsm fluff pulp + | 14.7 gsm | N/A | 24 gsm | 40 gsm fluff pulp + |
| | 20 gsm | bluegrass | | fertilizer | 12.5 gsm |
| | polyethylene | | | | polyethylene |
| | powder | | | | powder |
| 18 | 50 gsm fluff pulp + | 19.2 gsm | N/A | 24 gsm | 40 gsm fluff pulp + |
| | 20 gsm | bluegrass/ | | fertilizer | 12.5 gsm |
| | polyethylene | ryegrass | | | polyethylene |
| | powder | blend | | | powder |
| 19 | 50 gsm fluff pulp + | 48 gsm | N/A | 24 gsm | 40 gsm fluff pulp + |
| | 20 gsm | fescue | | fertilizer | 12.5 gsm |
| | polyethylene | | | | polyethylene |
| | powder | | | | powder |
| 20 | 50 gsm treated | 48 gsm | N/A | 24 gsm | 40 gsm treated |
| | pulp + 20 gsm | fescue | | fertilizer | pulp + 12.5 gsm |
| | polyethylene | | | | polyethylene |
| | powder | | | | powder |
| 21 | 50 gsm treated | 48 gsm | N/A | 24 gsm | 40 gsm treated |
| | pulp + 20 gsm | fescue | | fertilizer + | pulp + 12.5 gsm |
| | polyethylene | | | 10 gsm | polyethylene |
| | powder | | | superabsorbent | powder |
| | | | | polymer | |

Other Viability Testing:

All pilot examples were tested for germination. Samples of 6 through 10 ere cut to approximately 100 cm by 100 cm and placed in containers of potting soil with the carrier tissue away from the soil. Water was poured onto the tissue until the surface was visibly wet. Approximately twenty seeds of the appropriate type were also planted in the soil of the container as a control. The container was sealed into a plastic bag and placed in a sunny location. Grass growth was monitored visually. Examples 6 through 8 showed a very high rate of germination within 1 week of planting. Example 9 with fescue seeds did not germinate as readily because, at the low seed loading, many of the seeds were damaged by embossing. Examples 2 and 5 were also tested for germination in the lab. Both showed acceptable growth.

Examples 11-21 were tested for growth in an outside location. Samples measuring 216 mm by 280 mm were placed on prepared topsoil in a sunny location outside. The samples were positioned with the carrier tissue away from the soil and watered until the entire sample was visibly wet. The samples were monitored visually and watered as needed. Within a week, all of the materials had germinated. The germination rates of the fescue and bentgrass appeared to be high at one week. The bluegrass and bluegrass/ryegrass blend germination was much lower. Bluegrass typically takes about three weeks to germinate completely, so the low germination rate at one week is not unexpected.

Samples were tested for germination by cutting approximately 100 cm by 100 cm of substrate and placing it in containers of potting soil with the carrier tissue away from the soil. Water was poured onto the tissue until the surface was visibly wet. This resulted in the product coming in intimate contact with the ground. Germination was evaluated at the end of the given period of time by checking each individual seed for germination. A sufficient period of time was allowed to ensure that any viable seeds were germinated.

TABLE 5
Germination Rates for Examples 16 and 26

| Example | Time from planting | Germination Rate |
|---|---|---|
| 16 | 45 days | 96 percent |
| 26 | 47 | 80 percent |

### Example 22

### Preparation of Seed Pads With a Wax Binder and Fertilizer Using a Patterned Emboss Wire

A 1-ply 18 gsm carrier tissue (CelluTissue 3204) was unrolled onto a printed fabric (cross-hatch pattern printed at a height of 1 mm onto spiral wire using silicone, Voith Fabrics Advanced Concepts, Blackburn, England) installed onto the forming section of a pilot airlaid machine containing three forming heads. The first or bottom layer of the material contained 40 gsm of FOLEY FLUFFS®, fluff pulp mixed with 11 gsm of prilled paraffin wax (MIWSH 109 mini prilled, Moore and Munger, Inc., Shelton, Conn.). The MIWSH 109 grade wax has a drop melting point of 73.9° C., and a congealing point of 72.2° C. An intermediate layer of 14.7 gsm seeds (bluegrass seeds, Lesco) was added to the web through a drop spreader (AccuGreen 1000) mounted between the first and second forming heads. Nothing was added through the second forming head. A layer of 12 gsm of fertilizer (Miniphos 8-30-15, Simplot Turf and Horticulture, Lathrop, Calif.) was added through a second drop spreader (AccuGreen 1000) mounted between the second and third forming heads. A second layer of 30 gsm of FOLEY FLUFFS® fluff pulp mixed with 9.0 gsm of prilled paraffin wax (MIWSH 109 mini prilled, 78° C. melting point,) was added through the third forming head. A smooth steel compaction roll after the third forming head was heated to 85° C. The compaction roll was pressed onto the web. The heat, combined with 300 kPa of pressure, melted the wax in the emboss areas to bond the web. The discontinuous bonding of the web causes minimal heat shock to the agricultural additives. A roll of this web was collected at an overall basis weight of 135 gsm and a density of 0.1 g/cc.

### Example 23

### Preparation of Bluegrass Pads With a Wax Binder and Fertilizer Using a Patterned Emboss Wire With Increased Pressure

The pad was prepared as in Example 22, except that 400 kPa of pressure was applied to the heated compaction roll. The pad had an overall basis weight of 135 gsm and a density of 0.1 g/cc.

### Example 24

### Preparation of Pads With a Wax Binder and Fertilizer Using a Patterned Emboss Wire With Increased Pressure

The pad was prepared as in Example 23, except that 500 kPa of pressure was applied to the heated compaction roll. The pad had an overall basis weight of 135 gsm and a density of 0.1 g/cc.

### Example 25

### Preparation of Pads With a Wax Binder and Fertilizer Using a Patterned Emboss Wire With Increased Pressure

The pad was prepared as in Example 24, except that 600 kPa of pressure was applied to the heated compaction roll. The pad had an overall basis weight of 135 gsm and a density of 0.1 g/cc.

### Example 26

### Preparation of Fescue Pads With a Wax Binder and Fertilizer Using a Patterned Emboss Wire

The pad was prepared as in Example 25, except that 38.4 gsm of fescue seeds (Lesco) was fed through the drop spreader mounted between forming heads one and two. The pressure on the compaction roll as reduced to 300 kPa. The pad had an overall basis weight of 158 gsm and a density of 0.1 g/cc.

### Example 27

### Preparation of Bluegrass/Ryegrass Pads With a Wax Binder and Fertilizer Using a Patterned Emboss Wire

The pad was prepared as in Example 26, except that 19.2 gsm of a blend of 50 percent bluegrass and 50 percent rye grass (Lesco) was fed through the drop spreader mounted between forming heads one and two. The pad had an overall basis weight of 139 gsm and a density of 0.1 g/cc.

### Example 28

### Preparation of Bluegrass/Ryegrass Pads With a Wax Binder and Fertilizer Using a Heated Emboss Roll

The pad was prepared as in Example 27, except that the heated smooth compaction roll was lifted. A patterned emboss roll was installed in the transfer section of the airlaid machine and heated to 85° C. The pattern on the roll consisted of about 5 percent of the roll's total area. The emboss roll was pressed onto the web. The heat, combined with 200 kPa of pressure, melted the wax in the emboss areas to bond the web. The pad had an overall basis weight of 139 gsm and a density of 0.1 g/cc.

TABLE 6
Formation Description for Examples 22 through 28.

| | | Drop | Forming | Drop | |
|---|---|---|---|---|---|
| Example | Forming Head 1 | Spreader | Head 2 | Spreader | Forming Head 3 |
| 22 | 40 gsm fluff pulp + | 14.7 gsm | N/A | 12 gsm | 30 gsm fluff pulp + |
| | 11 gsm MIWSH | bluegrass | | fertilizer | 10 gsm MIWSH |
| | 109 prilled wax | | | | 109 prilled wax |
| 23 | 40 gsm fluff pulp + | 14.7 gsm | N/A | 12 gsm | 30 gsm fluff pulp + |
| | 11 gsm MIWSH | bluegrass | | fertilizer | 10 gsm MIWSH |
| | 109 prilled wax | | | | 109 prilled wax |
| 24 | 40 gsm fluff pulp + | 14.7 gsm | N/A | 12 gsm | 30 gsm fluff pulp + |
| | 11 gsm MIWSH | bluegrass | | fertilizer | 10 gsm MIWSH |
| | 109 prilled wax | | | | 109 prilled wax |
| 25 | 40 gsm fluff pulp + | 14.7 gsm | N/A | 12 gsm | 30 gsm fluff pulp + |
| | 11 gsm MIWSH | bluegrass | | fertilizer | 10 gsm MIWSH |
| | 109 prilled wax | | | | 109 prilled wax |
| 26 | 40 gsm fluff pulp + | 38.4 gsm | N/A | 12 gsm | 30 gsm fluff pulp + |
| | 11 gsm MIWSH | fescue | | fertilizer | 10 gsm MIWSH |
| | 109 prilled wax | | | | 109 prilled wax |
| 27 | 40 gsm fluff pulp + | 19.2 gsm | N/A | 12 gsm | 30 gsm fluff pulp + |
| | 11 gsm MIWSH | bluegrass/ | | fertilizer | 10 gsm MIWSH |
| | 109 prilled wax | ryegrass | | | 109 prilled wax |
| | | blend | | | |
| 28 | 40 gsm fluff pulp + | 19.2 gsm | N/A | 12 gsm | 30 gsm fluff pulp + |
| | 11 gsm MIWSH | bluegrass/ | | fertilizer | 10 gsm MIWSH |
| | 109 prilled wax | ryegrass | | | 109 prilled wax |
| | | blend | | | |

### Example 29

### Preparation of Seed Pads With a Wax Binder and Fertilizer Using a Patterned Emboss Wire

A 1-ply 18 gsm carrier tissue (CelluTissue 3204) was unrolled onto a spiral forming wire of a pilot airlaid machine containing three forming heads. The first or bottom layer of the material contained 40 gsm of FOLEY FLUFFS® fluff pulp mixed with 11 gsm of prilled paraffin wax (MIWSH 109 mini prilled). An intermediate layer of 14.7 gsm seeds (bluegrass seeds, Lesco) was added to the web through a drop spreader (AccuGreen 1000) mounted between the first and second forming heads. Nothing was added through the second forming head. A layer of 12 gsm of fertilizer (Miniphos 8-30-15) was added through a second drop spreader (AccuGreen 1000) mounted between the second and third forming heads. A second layer of 30 gsm of FOLEY FLUFFS® fluff pulp mixed with 9.0 gsm of prilled paraffin wax (MIWSH 109 mini prilled) was added through the third forming head. A smooth steel compaction roll after the third forming head was heated to 85° C. The compaction roll was pressed onto the web. The heat, combined with 300 kPa of pressure, melted the wax to bond the web. A roll of this web was collected at an overall basis weight of 135 gsm and a density of 0.1 g/cc.

### Example 30

### Preparation of Bluegrass Pads With a Wax Binder and Fertilizer With Increased Pressure

The pad was prepared as in Example 29, except that 400 kPa of pressure was applied to the heated compaction roll. The pad had an overall basis weight of 135 gsm and a density of 0.1 g/cc.

### Example 31

### Preparation of Pads With a Wax Binder and Fertilizer With Increased Pressure

The pad was prepared as in Example 30, except that 500 kPa of pressure was applied to the heated compaction roll. The pad had an overall basis weight of 135 gsm and a density of 0.1 g/cc.

### Example 32

### Preparation of Pads With a Wax Binder and Fertilizer With Increased Pressure

The pad was prepared as in Example 31, except that 600 kPa of pressure was applied to the heated compaction roll. The pad had an overall basis weight of 135 gsm and a density of 0.1 g/cc.

### Example 33

### Preparation of Fescue Pads With a Wax Binder and Fertilizer

The pad was prepared as in Example 32, except that 38.4 gsm of fescue seeds (Lesco) was fed through the drop spreader mounted between forming heads one and two. The pressure on the compaction roll as reduced to 300 kPa. The pad had an overall basis weight of 158 gsm and a density of 0.1 g/cc.

### Example 34

### Preparation of Bluegrass/Ryegrass Pads With a Wax Binder and Fertilizer

The pad was prepared as in Example 33, except that 19.2 gsm of a blend of 50 percent bluegrass and 50 percent rye grass (Lesco) was fed through the drop spreader mounted between forming heads one and two. The pad had an overall basis weight of 139 gsm and a density of 0.1 g/cc.

TABLE 7
Formation Description for Examples 29 through 34.

| | | Drop | Forming | Drop | |
|---|---|---|---|---|---|
| Example | Forming Head 1 | Spreader | Head 2 | Spreader | Forming Head 3 |
| 29 | 40 gsm fluff pulp + | 14.7 gsm | N/A | 12 gsm | 30 gsm fluff pulp + |
| | 11 gsm MIWSH | bluegrass | | fertilizer | 10 gsm MIWSH |
| | 109 prilled wax | | | | 109 prilled wax |
| 30 | 40 gsm fluff pulp + | 14.7 gsm | N/A | 12 gsm | 30 gsm fluff pulp + |
| | 11 gsm MIWSH | bluegrass | | fertilizer | 10 gsm MIWSH |
| | 109 prilled wax | | | | 109 prilled wax |
| 31 | 40 gsm fluff pulp + | 14.7 gsm | N/A | 12 gsm | 30 gsm fluff pulp + |
| | 11 gsm MIWSH | bluegrass | | fertilizer | 10 gsm MIWSH |
| | 109 prilled wax | | | | 109 prilled wax |
| 32 | 40 gsm fluff pulp + | 14.7 gsm | N/A | 12 gsm | 30 gsm fluff pulp + |
| | 11 gsm MIWSH | bluegrass | | fertilizer | 10 gsm MIWSH |
| | 109 prilled wax | | | | 109 prilled wax |
| 33 | 40 gsm fluff pulp + | 38.4 gsm | N/A | 12 gsm | 30 gsm fluff pulp + |
| | 11 gsm MIWSH | fescue | | fertilizer | 10 gsm MIWSH |
| | 109 prilled wax | | | | 109 prilled wax |
| 34 | 40 gsm fluff pulp + | 19.2 gsm | N/A | 12 gsm | 30 gsm fluff pulp + |
| | 11 gsm MIWSH | bluegrass/ | | fertilizer | 10 gsm MIWSH |
| | 109 prilled wax | ryegrass | | | 109 prilled wax |
| | | blend | | | |

### Example 35

### Preparation of Seed Pads With a Starch Binder and Drying With Oven at Various Temperatures

A 1-ply 18-gsm white carrier tissue (CelluTissue 3204) was unwound onto the forming wire of a three-head airlaid pilot machine. The first or bottom layer consisting of 80 gsm of Foley Fluffs® fluff pulp was fed through the first forming head onto the tissue.

An intermediate layer of 33 gsm of Foley Fluffs® fluff pulp mixed with 17.6-gsm of fescue seed (Transition Blend, LescoH) was fed through the second forming head. The seeds were added using a powder feeder (Coat-O-Matic 23″ DE-S, Christy Machine Company, Fremont, Ohio).

A top layer of 80-gsm of Foley Fluffs® fluff pulp was added through the third forming head.

The sample then went to a transfer station and was placed on a spray wire. The top layer was sprayed with 8.0-gsm of a 7.30% solids solution of EVA/PVA based binder (Vinac 911, Air Products, Allentown, Pa.). The sample was dried in a through air oven at 100° C. for 1-minute. The sample was manually rolled at the end of the oven. It was passed through the entire line a second time with the bottom side now facing up. The binder used in the first pass was applied to the bottom side at the same level and dried for the same amount of time in the through air oven at the same temperature. Other samples were made using the same method except that the oven temperature was set higher. Additional samples were prepare with oven temperature of 120° C., 140° C. and 160° C. Germination for the seeds in these samples was 0%. Nothing grew.

What is claimed is:

1. A bonded support for viable seeds comprising:
(A) a fiber matrix comprising cellulosic fibers,
(B) seeds,
(C) a binder activated by conditions of pressure and heat transfer to the support such that the seeds remain viable.

2. The support of claim 1, wherein the binder is activated by conditions of pressure and heat transfer to the support such that at least about 65 percent of the seeds remain viable.

3. The support of claim 2, wherein the binder is activated by conditions of pressure and heat transfer to the support such that at least about 80 percent of the seeds remain viable.

4. The support of claim 3, wherein the binder is activated by conditions of pressure and heat transfer to the support such that at least about 90 percent of the seeds remain viable.

5. The support of claim 1, wherein the binder has been activated within a residence time at an activation temperature which is less than a higher temperature at which viability of the seeds is reduced to less than about 65 percent.

6. The support of claim 5, wherein the binder is capable of activation within a residence time at an activation temperature which is less than a higher temperature at which viability of the seeds is reduced to less than about 80 percent.

7. The support of claim 6, wherein the binder is capable of activation within a residence time at an activation temperature which is less than a higher temperature at which viability of the seeds is reduced to less than about 90 percent.

8. The support of claim 1, wherein the support has been compacted or where from about 1 to about 99 percent of the surface area of the support has been embossed, and the binder has been activated in the compacted or embossed area.

9. The support of claim 8, wherein from about 1 to about 50 percent of the surface area of the support has been embossed.

10. The support of claim 9, wherein from about 1 to about 25 percent of the surface area of the support has been embossed.

11. The support of claim 10, wherein from about 1 to about 10 percent of the surface area of the support has been embossed.

12. The support of claim 11, wherein from about 1 to about 5 percent of the surface area of the support has been embossed.

13. The support of claim 1 further comprising fertilizer.

14. The support of claim 1 further comprising superabsorbent polymer or a humectant.

15. The support of claim 1, wherein the binder is a wax with a melting point of from about 40° C. to about 120° C.

16. The support of claim 1, wherein the binder is a thermoplastic material with a melting point of from about 60° C. to about 220° C.

17. The support of claim 1, wherein the binder is a polyolefin powder with a melting point from about 60° C. to about 220° C.

18. The support of claim 1, wherein the binder is a hot melt adhesive.

19. The support of claim 1, wherein the binder is a mixture comprising bicomponent fibers.

20. A support for the containment of viable seeds comprising:
(A) a first cellulosic layer containing cellulosic fibers and, optionally, a binder,
(B) a second cellulosic layer containing cellulosic fibers and, optionally, a binder,
(C) optionally, a cellulosic tissue,
(D) seeds distributed in a seed layer between the first cellulosic layer and the second cellulosic layer, or on a cellulosic tissue,
where binder is present in at least one of the cellulosic layers or is in a layer in contact with one of the cellulosic layers, and where the support has been compacted or where from about 1 to about 99 percent of the surface area of the support has been embossed, and the binder has been activated in the compacted or embossed area.

21. The support of claim 20 further comprising a fertilizer layer
(1) between the seed layer and either the first cellulosic layer or the second cellulosic layer, or
(2) on the surface opposed to the surface in contact with the seed layer of either the first cellulosic layer or the second cellulosic layer, or
(3) in contact with a layer of the support, or
(4) in admixture with a layer of the support.

22. The support of claim 1 further comprising a third cellulosic layer containing cellulosic fibers and, optionally, a binder.

23. The support of claim 1, wherein superabsorbent polymer is present in one or more layers of the support, or is present as a separate layer, optionally mixed with cellulosic fibers, binder or fibers and binder.

24. The support of claim 1, wherein the binder is a wax with a melting point of from about 40° C. to about 120° C.

25. The support of claim 1, wherein the binder is a thermoplastic material with a melting point of from about 60° C. to about 220° C.

26. The support of claim 1, wherein the binder is a polyolefin with a melting point from about 60° C. to about 220° C.

27. The support of claim 1, wherein seeds are distributed in the seed layer as mixture of seeds and cellulosic fibers.

28. A support for the containment of viable seeds comprising:
(A) a cellulosic tissue layer,
(B) optionally, a cellulosic layer containing
(1) cellulosic fibers
(2) binder
(C) a seed layer containing
(1) seeds
(2) optionally, cellulosic fibers
(3) optionally, binder
(4) optionally, fertilizer, and
(D) optionally, a fertilizer layer containing
(1) cellulosic fibers
(2) fertilizer, and
(3) optionally, binder, or
(DD) optionally, a cellulosic layer containing
(1) cellulosic fiber, and
(2) optionally, binder,
where one or more layers contain binder activated by conditions of pressure and heat transfer to the support such that the seeds remain viable, where at least one layer other than the cellulosic tissue layer contains cellulosic fibers and where the order of the layers is (A), (B) if present, (C), and, if present, (D) or (DD).

29. The support of claim 28, wherein superabsorbent polymer is present in one or more layers of the support, or is present as a separate layer, optionally mixed with cellulosic fibers, binder or fibers and binder.

30. The support of claim 28, wherein the binder is a wax with a melting point of from about 40° C. to about 120° C.

31. The support of claim 28, wherein the binder is a thermoplastic material with a melting point of from about 60° C. to about 220° C.

32. The support of claim 28, wherein the binder is a polyolefin with a melting point from about 60° C. to about 220° C.

33. The support of claim 28, wherein the binder is a mixture comprising bicomponent fibers.

34. The support of claim 28, wherein seeds are distributed in the seed layer as a mixture of seeds and cellulosic fibers.

35. The support of claim 28, wherein the is binder activated by conditions of pressure and heat transfer to the support such that at least about 65 percent of the seeds remain viable.

36. The support of claim 35, wherein the binder is activated by conditions of pressure and heat transfer to the support such that at least about 80 percent of the seeds remain viable.

37. The support of claim 36, wherein the binder is activated by conditions of pressure and heat transfer to the support such that at least about 90 percent of the seeds remain viable.

38. The support of claim 28, wherein the binder has been activated within a residence time at an activation temperature which is less than a higher temperature at which viability of the seeds is reduced to less than about 65 percent.

39. The support of claim 38, wherein the binder is capable of activation within a residence time at an activation temperature which is less than a higher temperature at which viability of the seeds is reduced to less than about 80 percent.

40. The support of claim 39, wherein the binder is capable of activation within a residence time at an activation temperature which is less than a higher temperature at which viability of the seeds is reduced to less than about 90 percent.

41. The support of claim 28, wherein the support has been compacted or where from about 1 to about 99 percent of the surface area of the support has been embossed, and the binder has been activated in the compacted or embossed area.

42. The support of claim 41, wherein from about 1 to about 50 percent of the surface area of the support has been embossed.

43. The support of claim 42, wherein from about 1 to about 25 percent of the surface area of the support has been embossed.

44. The support of claim 43, wherein from about 1 to about 10 percent of the surface area of the support has been embossed.

45. The support of claim 44, wherein from about 1 to about 5 percent of the surface area of the support has been embossed.

46. A process for the production of a seed support comprising:
(A) optionally, placing a cellulosic tissue on a forming wire of an airlaying machine,
(B) airlaying cellulosic fibers and, optionally, a binder on the cellulosic tissue or on the forming wire to form a first cellulosic layer,
(C) distributing a layer of seeds on the tissue from (A) or on the first cellulosic layer from (B) to form a seed layer,
(D) airlaying cellulosic fibers and, optionally, a binder on the seed layer from (C), or on another layer to form a second cellulosic layer,
(E) where binder is present in at least one of the cellulosic layers or is in a layer in contact with one of the cellulosic layers, and
(F) compacting the support or embossing from about 1 to about 99 percent of the surface area of the support to activate the binder in the compacted or embossed area.

47. The process of claim 46, wherein the binder is activated by conditions of pressure and heat transfer to the support such that the seeds remain viable.

48. The process of claim 47, wherein the binder is activated by conditions of pressure and heat transfer to the support such that at least about 65 percent of the seeds remain viable.

49. The process of claim 48, wherein the binder is activated by conditions of pressure and heat transfer to the support such that at least about 80 percent of the seeds remain viable.

50. The process of claim 49, wherein the binder is activated by conditions of pressure and heat transfer to the support such that at least about 90 percent of the seeds remain viable.

51. The process of claim 46, wherein the binder has been activated within a residence time at an activation temperature which is less than a higher temperature at which viability of the seeds is reduced to less than about 65 percent.

52. The process of claim 47, wherein the binder is capable of activation within a residence time at an activation temperature which is less than a higher temperature at which viability of the seeds is reduced to less than about 80 percent.

53. The process of claim 52, wherein the binder is capable of activation within a residence time at an activation temperature which is less than a higher temperature at which viability of the seeds is reduced to less than about 90 percent.

54. The process of claim 46, wherein the support has been compacted or where from about 1 to about 99 percent of the surface area of the support has been embossed, and the binder has been activated in the compacted or embossed area.

55. The process of claim 54, wherein from about 1 to about 50 percent of the surface area of the support has been embossed.

56. The process of claim 55, wherein from about 1 to about 25 percent of the surface area of the support has been embossed.

57. The process of claim 56, wherein from about 1 to about 10 percent of the surface area of the support has been embossed.

58. The process of claim 57, wherein from about 1 to about 5 percent of the surface area of the support has been embossed.

59. The process of claim 46 further comprising introducing fertilizer.

60. The process of claim 46 further comprising introducing superabsorbent polymer or a humectant.

61. The process of claim 46, wherein the binder is a wax with a melting point of from about 40° C. to about 120° C.

62. The process of claim 46, wherein the binder is a thermoplastic material with a melting point of from about 60° C. to about 220° C.

63. The process of claim 46, wherein the binder is a polyolefin powder with a melting point from about 60° C. to about 220° C.

64. The process of claim 46, wherein the binder is a hot melt adhesive.

65. The process of claim 46, wherein the binder is a mixture comprising bicomponent fibers.

66. A support produced by the process of claim 46.
